(19) United States
(12) Patent Application Publication
(10) Pub. No.: US 2022/0349526 A1
(43) Pub. Date: Nov. 3, 2022

(54) CRYOGENIC FLUID FUELING SYSTEM

(71) Applicant: Chart Inc., Ball Ground, GA (US)

(72) Inventor: Jan Kubica, Liberec (CZ)

(21) Appl. No.: 17/731,337

(22) Filed: Apr. 28, 2022

Related U.S. Application Data
(60) Provisional application No. 63/183,348, filed on May 3, 2021.

(51) Int. Cl. F17C 9/02

(52) U.S. Cl. CPC F17C 9/02; F17C 2223/0161; F17C 2221/033; F17C 2221/014; F17C 2227/0309; F17C 2227/0135

(57) ABSTRACT

A cryogenic fluid fueling system includes a first container configured to contain a first cryogenic liquid with a first headspace being positioned above the first cryogenic liquid. A heat exchanger vaporizes a portion of the first cryogenic liquid such that pressure within the first container is raised as vaporized cryogen moves into the first headspace. A second container is configured to contain a second cryogenic liquid with a second headspace being positioned above the second cryogenic liquid. A condensing coil is positioned within the second headspace of the second container and fluidically connected to the first interior of the first container such that a portion of the first cryogenic liquid is propelled into the condensing coil and is warmed to provide a first cryogenic vapor.

### CLAIM OF PRIORITY

This application claims the benefit of U.S. Provisional Application No. 63/183,348, filed May 3, 2021, the contents of which are hereby incorporated by reference.

### FIELD OF THE DISCLOSURE

The present disclosure relates generally to dispensing systems for cryogenic fluids and, more particularly, to a system for fueling an on-board vehicle tank or other use device with a cryogenic fuel.

### BACKGROUND

Cryogenic fluids find use as fuels in a variety of industrial processes and vehicles. Natural gas is a cryogenic fluid useful as an alternative fuel source for powering vehicle engines. It is typically stored and transported as liquefied natural gas (LNG) because it occupies a much smaller volume (approximately 1/600^{th} the gaseous state). Temperature and pressure regulation of liquefied natural gas during storage is extremely important. Liquefied natural gas is typically stored in insulated cryogenic tanks because of the low temperature requirements (˜−160° C.) and typically at lower pressures. Furthermore, in fueling station applications, the stored cryogenic liquid is typically saturated, so that the gas and liquid states simultaneously exist at a desired temperature and pressure.

Liquefied or liquid nitrogen (LIN) is often used in LNG fueling stations for maintaining low temperature within the LNG storage tanks. The LNG tanks often feature a condensing coil in the tank headspace. Liquid nitrogen boils inside the condensing coil, and this causes natural gas vapors to condense on the coil's surface. Prior art LNG tanks often vent the evaporated nitrogen to the atmosphere. Additionally, sometimes nitrogen vapors are taken from the top of a liquid nitrogen tank associated with the LNG tank, and warmed up in an ambient air heat exchanger to be utilized as instrument air for valve actuation, purging and inerting.

In such prior art LNG tanks, the liquid nitrogen tank is separated from the LNG tank which increases the equipment footprint and system costs. Additionally, nitrogen vapor (from the coil) is not utilized in the system and instead is directly vented into the atmosphere. At the same time, liquid nitrogen from the LIN tank is evaporated in a pressure building heat exchanger in order to build pressure in the LIN tank and to generate heated vapor to be used as instrument air. This results in unnecessary heat input into the system.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a cryogenic fluid fueling system includes a first container comprising a first inner vessel and a first outer shell wherein the first inner vessel defines a first interior configured to contain a first cryogenic liquid with a first headspace being positioned above the first cryogenic liquid. A heat exchanger is fluidically connected to the first container and is configured to vaporize a portion of the first cryogenic liquid, such that pressure within the first container is raised as vaporized cryogen moves from the heat exchanger into the first headspace. A second container includes a second inner vessel and a second outer shell wherein the second inner vessel defines a second interior. The second interior is configured to contain a second cryogenic liquid with a second headspace being positioned above the second cryogenic liquid. A condensing coil is positioned within the second headspace of the second container and is fluidically connected to the first interior of the first container such that a portion of the first cryogenic liquid is propelled into the condensing coil and is warmed to provide a first cryogenic vapor.

In a second aspect, a cryogenic fluid fueling system includes a first container having a first inner vessel and a first outer shell wherein the first inner vessel defines a first interior configured to contain a first cryogenic liquid with a first headspace being positioned above the first cryogenic liquid. A second container has a second inner vessel and a second outer shell wherein the second inner vessel defines a second interior. The second interior configured to contain a second cryogenic liquid with a second headspace being positioned above the second cryogenic liquid. A heat exchanger is positioned within the second container and is fluidically associated with the first container so as to vaporize a portion of the first cryogenic liquid such that pressure within the first container is raised as vaporized cryogen moves from the heat exchanger into the first headspace. A condensing coil is positioned within the second headspace of the second container. The condensing coil is fluidically connected to the first interior of the first container such that a portion of the first cryogenic liquid is propelled into the condensing coil and is warmed to provide a first cryogenic vapor.

### BRIEF DESCRIPTION OF THE DRAWINGS

FIG. 1 is a schematic illustration of one embodiment of the cryogenic fluid fueling system of the disclosure;

FIG. 2 is a schematic illustration of a second embodiment of the cryogenic fluid fueling system of the disclosure;

FIG. 3 is a schematic illustration of a third embodiment of the cryogenic fluid fueling system of the disclosure;

FIG. 4 is a graph of temperatures of liquid nitrogen corresponding to pressures in an example pressure operating range in the first container of FIGS. 1-3 and temperatures of liquid natural gas (“Methane”) corresponding to pressures in an example pressure operating range in the second container of FIGS. 1-3;

FIG. 5 is a table of temperatures of liquid nitrogen corresponding to pressures in an example pressure operating range in the first container of FIGS. 1-3 and temperatures of liquid natural gas (“Methane”) corresponding to pressures in an example pressure operating range in the second container of FIGS. 1-3.

### DETAILED DESCRIPTION OF EMBODIMENTS

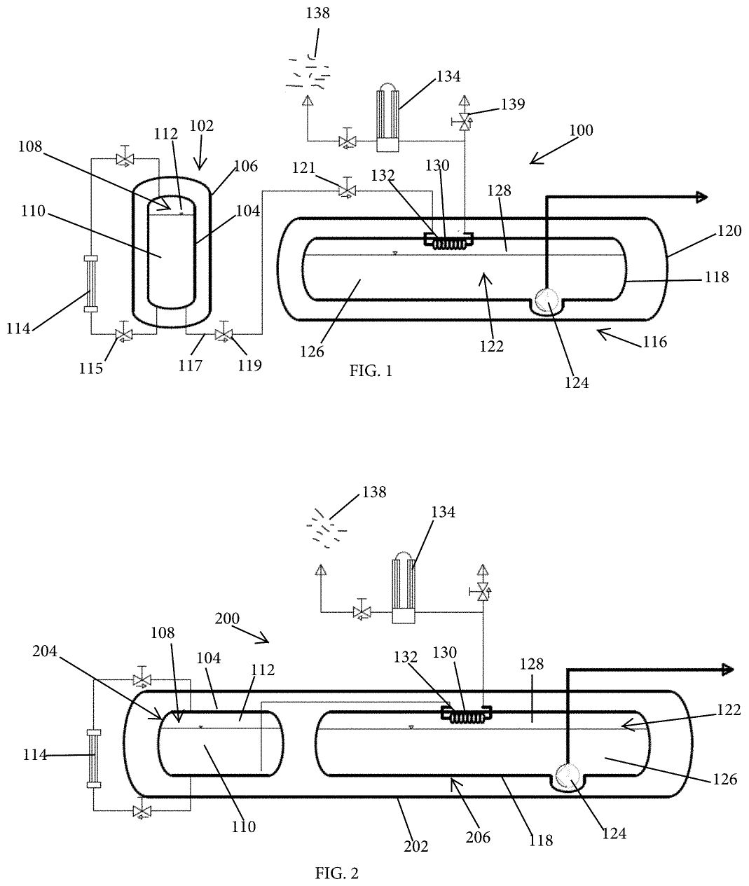

FIG. 1 shows an embodiment of a cryogenic fluid fueling system, indicated in general at 100, including a first container, indicated in general at 102, having a first inner vessel 104 and a first outer shell 106 with an insulation space defined therebetween. A vacuum is preferably drawn on, or air is at least partially evacuated from, the insulation space. The first inner vessel 104 defines a first container interior, indicated in general at 108, containing a first cryogenic liquid 110 with a first headspace 112 positioned above the first cryogenic liquid 110. In the present embodiment, and in the embodiments described below, the first cryogenic liquid 110 is liquid nitrogen.

A heat exchanger 114 is fluidically associated with the first container 102. More specifically, the heat exchanger 114 serves as a pressure building unit (PBU) and is configured, when valve 115 is opened, to vaporize a portion of the liquid nitrogen 110, such that pressure within the first container 102 is raised as the vaporized nitrogen moves from the heat exchanger 114 into the first headspace 112. The pressure increase in the first interior 108 drives liquid nitrogen out of the first container 102 via line 117 when valves 119 and 121 are opened.

The system 100 also includes a second container, indicated in general at 116, having a second inner vessel 118 and a second outer shell 120 with an insulation space defined therebetween. A vacuum is preferably drawn on, or air is at least partially evacuated from, the insulation space. The second inner vessel 118 defines a second interior 122 having a pump 124 positioned therein and configured to direct cryogenic liquid out of the tank to an on-board vehicle tank or other use device (not shown). The pump 124 may be any appropriate liquid pump known in the art. The second container interior, indicated in general at 122, is configured to contain a second cryogenic liquid 126, which is a cryogenic fuel, with a second headspace 128 being positioned above the second cryogenic liquid 126. In the present embodiment, and in the embodiments described below, the second cryogenic liquid 126 is liquid natural gas.

A condensing coil 130 having a surface 132 is positioned within the second headspace 128 of the second container 116. The condensing coil 130 may be any appropriate condensing coil known in the art. The condensing coil 130 is fluidically connected to the first interior 108 of the liquid nitrogen container. More specifically, as described above, after the pressure in the first interior 108 propels liquid nitrogen 110 out of the first container 102 via line 117, the liquid nitrogen 110 flows into the condensing coil 130. The liquid nitrogen 110 causes natural gas vapor within headspace 128 of the liquid natural gas container to condense on the surface 132 and return to the LNG 126 below. As a result, the pressure within the second container interior 122 is reduced as the headspace pressure is collapsed and the LNG 126 is cooled. The LNG 126 is pumped out of the second container 116 and system 100 to the vehicle fuel tank by the pump 124.

A heater 134 is fluidically connected to the outlet of the condensing coil 130, such that nitrogen vapor from the condensing coil is heated by the heater 134. The heater 134 may be any appropriate heater known in the art, including, but not limited to, a heat exchanger (ambient air or other warming fluid), an electric heater or a heater using another power source. The heated nitrogen vapor 138 is directed out of the system for use as instrument air. As non-limiting examples, use as instrument air may include using the warmed nitrogen vapor for valve actuation, purging and inerting. A portion (or all) of the nitrogen vapor from condensing coil 130 may optionally be vented to atmosphere via vent valve 139 instead of being directed to the heater 134.

Turning next to FIG. 2, a cryogenic fluid fueling system, indicated in general at 200, has many of the features of the system 100 of FIG. 1. However, in the embodiment of FIG. 2, the first outer shell (shown at 106 in FIG. 1) and the second outer shell (shown at 120 in FIG. 1) are unitary and form a singular, unitary outer shell 202. The unitary outer shell 202 contains the first inner vessel, indicated at 204, and the second inner vessel, indicated in general at 206, such that the first and second inner vessels are in the same enclosed insulation space 207. A vacuum is preferably drawn on, or air is at least partially evacuated from, the insulation space 207. Such an arrangement provides a more compact fueling station, reduces overall material costs for the tanks and requires maintenance of only a single insulation space.

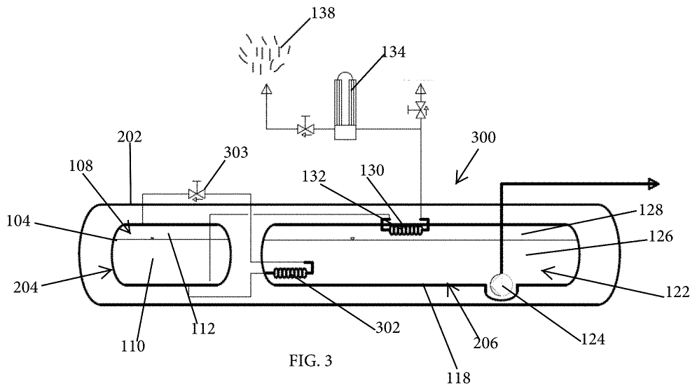

Turning next to FIG. 3, the delivery tank system 300 of FIG. 3 has many of the features of the system 200 of FIG. 2. However, in the embodiment of FIG. 3, a heat exchanger 302 is positioned within the second inner vessel 206 and submerged in the liquid natural gas 126 so that the LNG is used as a heating source for liquid nitrogen flowing through the heat exchanger. As a result, the heat exchanger 302 serves as a PBU for the nitrogen tank. As shown in FIG. 3, the system 300 is configured to direct a portion of the liquid nitrogen 110 to the heat exchanger 302, so that the portion of the liquid nitrogen is vaporized. When PBU valve 303 of FIG. 3 is opened, the vaporized nitrogen travels from the heat exchanger 302 into the first headspace 112. As described in the description of FIG. 1, the vaporized nitrogen in the first headspace 112 builds pressure within the first interior 108 and forces the liquid nitrogen 110 into the condensing coil 130.

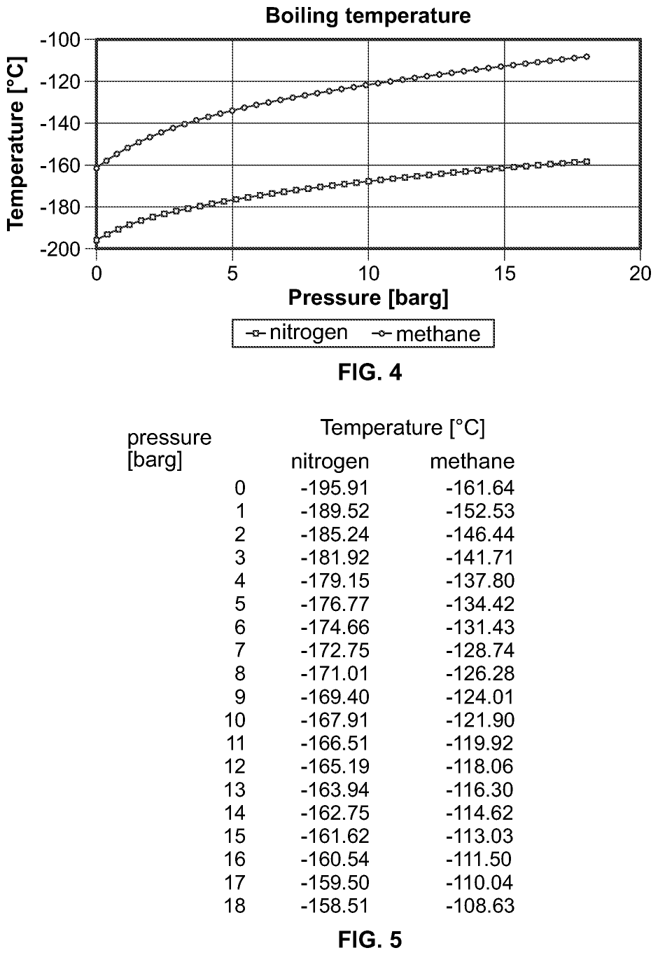

As non-limiting examples, where the first container contains liquified nitrogen and the second container contains liquified natural gas, the design pressure for the first container and the second container may be 11 barg. An example pressure operating range for the first container is 6 to 10 barg. An example pressure operating range for the second container is 0 to 10 barg. Temperatures of the liquid nitrogen and the liquefied natural gas corresponding to these pressures are shown in the graph of FIG. 4 and the table of FIG. 5, where the LNG is “Methane.”

All fluidic connections described above may be made by any appropriate known gas and/or liquid piping. Each time an element is described above as fluidically connected to another element, one or more pipes may act as a conduit between the element and the other element. Additionally, all system valves may be controlled to provide the above functionality by a control system including a micro-processor, CPU or other computer device.

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A cryogenic fluid fueling system, comprising:
a first container comprising a first inner vessel and a first outer shell wherein the first inner vessel defines a first interior configured to contain a first cryogenic liquid with a first headspace being positioned above the first cryogenic liquid;
a heat exchanger fluidically connected to the first container, the heat exchanger being configured to vaporize a portion of the first cryogenic liquid, such that pressure within the first container is raised as vaporized cryogen moves from the heat exchanger into the first headspace;
a second container comprising a second inner vessel and a second outer shell wherein the second inner vessel defines a second interior configured to contain a second cryogenic liquid with a second headspace being positioned above the second cryogenic liquid;
a condensing coil positioned within the second headspace of the second container, the condensing coil fluidically connected to the first interior of the first container such that a portion of the first cryogenic liquid is propelled into the condensing coil and is warmed to provide a first cryogenic vapor.

2. The cryogenic fluid fueling system of claim 1 wherein the first outer shell and the second outer shell are unitary so that a unitary outer shell is formed.

3. The cryogenic fluid fueling system of claim 2 wherein an insulation space defined between the unitary outer shell and the first and second inner vessels is at least partially evacuated of air.

4. The cryogenic fluid fueling system of claim 1 wherein the heat exchanger is positioned within the second container and is configured to be submerged within the second cryogenic liquid within the second container.

5. The cryogenic fluid fueling system of claim 1 wherein the first cryogenic liquid is liquid nitrogen and the second cryogenic liquid is liquefied natural gas.

6. The cryogenic fluid fueling system of claim 1 wherein the first cryogenic liquid is liquid nitrogen.

7. The cryogenic fluid fueling system of claim 1 wherein the second cryogenic liquid is liquified natural gas.

8. The cryogenic fluid fueling system of claim 1 wherein the use as instrument air includes actuating at least one valve configured to regulate fluid connections of the system, purging or inerting.

9. The cryogenic fluid fueling system of claim 1 further comprising a vent valve in fluid communication with the outlet of the condensing coil.

10. The cryogenic fluid fueling system of claim 1 wherein a pump is positioned within the second interior.

11. The cryogenic fluid fueling system of claim 1 further comprising a heater fluidically connected to an outlet of the condensing coil, such that at least a portion of a first cryogenic vapor is heated by the heater, wherein the system is configured to direct the heated portion of the first cryogenic vapor for use as instrument air.

12. A cryogenic fluid fueling system, comprising:
a first container comprising a first inner vessel and a first outer shell wherein the first inner vessel defines a first interior configured to contain a first cryogenic liquid with a first headspace being positioned above the first cryogenic liquid;
a second container comprising a second inner vessel and a second outer shell wherein the second inner vessel defines a second interior configured to contain a second cryogenic liquid with a second headspace being positioned above the second cryogenic liquid;
a heat exchanger positioned within the second container and fluidically associated with the first container, the heat exchanger being configured to vaporize a portion of the first cryogenic liquid, such that pressure within the first container is raised as vaporized cryogen moves from the heat exchanger into the first headspace;
a condensing coil positioned within the second headspace of the second container, the condensing coil fluidically connecting to the first interior of the first container such that a portion of the first cryogenic liquid is propelled into the condensing coil and is warmed to provide a first cryogenic vapor.

13. The cryogenic fluid fueling system of claim 12 wherein the heat exchanger is a coil.

14. The cryogenic fluid fueling system claim 12 wherein the first outer shell and the second outer shell are unitary.

15. The cryogenic fluid fueling system of claim 12 wherein the first cryogenic liquid is liquid nitrogen and the second cryogenic liquid is liquefied natural gas.

16. The cryogenic fluid fueling system of claim 12 wherein the first cryogenic liquid is liquid nitrogen.

17. The cryogenic fluid fueling system of claim 12 wherein the second cryogenic liquid is liquified natural gas.

18. The cryogenic fluid fueling system of claim 12 wherein a pump is positioned in the second interior.
